(19) United States
(12) Patent Application Publication
(10) Pub. No.: US 2006/0250345 A1
(43) Pub. Date: Nov. 9, 2006

(54) Scanning circuit, scanning device, image display apparatus and television apparatus

(75) Inventors: Kenji Shino, Yokohama-shi (JP); Yasukazu Noine, Chigasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/406,443

(22) Filed: Apr. 19, 2006

(30) Foreign Application Priority Data
Apr. 26, 2005 (JP) 2005-128077
Apr. 14, 2006 (JP) 2006-112036

(51) Int. Cl. G09G 3/36

(52) U.S. Cl. 345/100

(57) ABSTRACT

A scanning circuit having a plurality of output units each outputs an ON potential sequentially, comprises: a first output unit that changes an ON potential to an OFF potential during a first period; and a second output unit that changes the OFF potential to the ON potential during a second period, wherein at least part of the first period and at least part of the second period overlap.

### BACKGROUND OF THE INVENTION

1. Field of the Invention

The present invention relates to a scanning circuit, a scanning device, an image display apparatus, and a television apparatus.

2. Description of the Related Art

A method of performing a two line simultaneous drive and shifting a row selecting line at high speed with a double speed shift clock is disclosed in Japanese Laid-Open Patent Publication No. 11-24622. Further, a method of stabilizing the driving waveform using drive means of different impedance is disclosed in Japanese Laid-Open Patent Publication No. 2004-4429.

The technique disclosed in Japanese Laid-Open Patent Publication No. 11-24622 is a technique of simultaneously selecting two lines of the display lines with a clock signal and an output enable signal in a specific color drawing section at the upper part of the screen and in a specific color drawing section at the lower part of the screen, and decimating the image signal and performing compression drawing in the picture displaying section at the center to prevent malfunction of the vertical driver.

The technique disclosed in Japanese Laid-Open Patent Publication No. 2004-4429 is a technique of suppressing the waveform unevenness at the rise and decay of the driving waveform by means of a plurality of drive drivers having different impedances.

### SUMMARY OF THE INVENTION

The present invention aims to provide a scanning circuit, a scanning device, an image display apparatus, and a television apparatus capable of suppressing the reduction of the display period due to the presence of the transition period.

To achieve above-mentioned object, according to a first aspect of the present invention, there is provided a scanning circuit having a plurality of output units each outputs an ON potential sequentially, comprising:

a first output unit that changes an ON potential to an OFF potential taking a first period; and

a second output unit that changes the OFF potential to the ON potential taking a second period, wherein

at least part of the first period and at least part of the second period overlap. Here, it is suitable that the first period is equal to or more than 100 nsec. Also, it is suitable that the second period is equal to or more than 100 nsec. The first period can be measured as time potential changes from a state that ON potential is outputted to a state that OFF potential is stably outputted. The second period can be measured as time potential changes from a state that OFF potential is outputted to a state that ON potential is stably outputted. Moreover, it is suitable that the overlapping rate is 50% or more of the first period or the second period.

According to a second aspect of the present invention, there is provided a scanning circuit for scanning a plurality of scanning wirings, comprising:

a first output unit connected to a first scanning wiring; and

a second output unit connected to a scanning wiring different from the first scanning wiring, wherein

the first output unit starts an output with a first driving ability to start a change for approaching a signal level to be output to a signal level of a non-selected state, when the first output unit is in a state performing an output of a signal level for having the first scanning wiring to a selected state, and starts an output with a second driving ability greater than the first driving ability after a first period;

the second output unit starts an output by a third driving ability to start a change for approaching a signal level to be output to a signal level of a selected state, when the second output unit is in a state performing an output of a signal level for having the scanning wiring to be selected after the first scanning wiring is selected to a non-selected state, and starts an output with a fourth driving ability greater than the third driving ability after a second period; and

at least part of the first period and at least part of the second period are overlapped.

The driving ability can be expressed as a current amount that can be flowed. Further, it can be expressed by a value of resistance.

It is particularly suitable for the signal level at which the first output unit has the first scanning wiring to the selected state and the signal level at which the second output unit has the scanning wiring connected to the second output unit to the selected state to be the same.

It is particularly suitable for the signal level at which the first output unit has the first scanning wiring to the non-selected state and the signal level at which the second output unit has the scanning wiring connected to the second output unit to the non-selected state to be the same.

According to a third aspect of the present invention, preferably in the second aspect of the invention, the first scanning wiring is maintained at the signal level of a non-selected state by the second driving ability, and the scanning wiring to be selected after the first wiring is maintained at the signal level of the selected state by the fourth driving ability.

According to a forth aspect of the present invention, there is provided a scanning circuit for scanning a plurality of scanning wirings, comprising:

a first output unit connected to a first scanning wiring; and

a second output unit connected to a scanning wiring different from the first scanning wiring, wherein

the first output unit includes:

a first driving transistor for switching from an OFF state to an ON state to start a change of approaching a signal level to be output to a signal level of a non-selected state when the first output unit is in a state performing an output of a signal level for having the first scanning wiring to a selected state; and

a second driving transistor, maintained at an OFF state when the first driving transistor is switched from the OFF state to the ON state, for switching from an OFF state to an ON state after a first period from when the first driving transistor is switched from the OFF state to the ON state;

the second output unit includes:

a third driving transistor for switching from an OFF state to an ON state to start a change of approaching a signal level to be output to a signal level of a selected state when the second output unit is in a state performing an output of a signal level for having a scanning wiring to be selected after the first scanning wiring is selected to a non-selected state; and

a fourth driving transistor, maintained at an OFF state when the third driving transistor is switched from the OFF state to the ON state, for switching from an OFF state to an ON state after a second period from when the third driving transistor is switched from the OFF state to the ON state;

the second driving transistor has a driving ability greater than the first driving transistor; and

at least part of the first period and at least part of the second period are overlapped.

According to a fifth aspect of the present invention, there is provided a scanning circuit for scanning a plurality of scanning wirings, comprising:

a first output unit connected to a first scanning wiring; and

a second output unit connected to a scanning wiring different from the first scanning wiring, wherein

the first output unit includes:

a first driving transistor for switching from an OFF state to an ON state to start a change of approaching a signal level to be output to a signal level of a non-selected state when the first output unit is in a state performing an output of a signal level for having the first scanning wiring to a selected state; and

a second driving transistor, maintained at an OFF state when the first driving transistor is switched from the OFF state to the ON state, for switching from an OFF state to an ON state after a first period from when the first driving transistor is switched from the OFF state to the ON state;

the second output unit includes:

a third driving transistor for switching from an OFF state to an ON state to start a change of approaching a signal level to be output to a signal level of a selected state when the second output unit is in a state performing an output of a signal level for having a scanning wiring to be selected after the first scanning wiring is selected to a non-selected state; and

a fourth driving transistor, maintained at an OFF state when the third driving transistor is switched from the OFF state to the ON state, for switching from an OFF state to an ON state after a second period from when the third driving transistor is switched from the OFF state to the ON state;

the fourth driving transistor has a driving ability greater than the third driving transistor; and

at least part of the first period and at least part of the second period are overlapped.

According to a sixth aspect of the present invention, there is provided a scanning circuit for scanning a plurality of scanning wirings, comprising:

a first output unit connected to a first scanning wiring; and

a second output unit connected to a scanning wiring different from the first scanning wiring, wherein

the first output unit includes:

a first driving transistor for switching from an OFF state to an ON state to start a change of approaching a signal level to be output to a signal level of a non-selected state when the first output unit is in a state performing an output of a signal level for having the first scanning wiring to a selected state; and

a second driving transistor, maintained at an OFF state when the first driving transistor is switched from the OFF state to the ON state, for switching from an OFF state to an ON state after a first period from when the first driving transistor is switched from the OFF state to the ON state;

the second output unit includes:

a third driving transistor for switching from an OFF state to an ON state to start a change of approaching a signal level to be output to a signal level of a selected state when the second output unit is in a state performing an output of a signal level for having a scanning wiring to be selected after the first scanning wiring is selected to a non-selected state; and

a fourth driving transistor, maintained at an OFF state when the third driving transistor is switched from the OFF state to the ON state, for switching from an OFF state to an ON state after a second period from when the third driving transistor is switched from the OFF state to the ON state;

the second driving transistor is switched from the OFF state to the ON state while maintaining the ON state of the first driving transistor; and

at least part of the first period and at least part of the second period are overlapped.

According to a seventh aspect of the present invention, there is provided a scanning circuit for scanning a plurality of scanning wirings, comprising:

a first output unit connected to a first scanning wiring; and

a second output unit connected to a scanning wiring different from the first scanning wiring, wherein

the first output unit includes:

a first driving transistor for switching from an OFF state to an ON state to start a change of approaching a signal level to be output to a signal level of a non-selected state when the first output unit is in a state performing an output of a signal level for having the first scanning wiring to a selected state; and

a second driving transistor, maintained at an OFF state when the first driving transistor is switched from the OFF state to the ON state, for switching from an OFF state to an ON state after a first period from when the first driving transistor is switched from the OFF state to the ON state;

the second output unit includes:

a third driving transistor for switching from an OFF state to an ON state to start a change of approaching a signal level to be output to a signal level of a selected state when the second output unit is in a state performing an output of a signal level for having a scanning wiring to be selected after the first scanning wiring is selected to a non-selected state; and

a fourth driving transistor, maintained at an OFF state when the third driving transistor is switched from the OFF state to the ON state, for switching from an OFF state to an ON state after a second period from when the third driving transistor is switched from the OFF state to the ON state;

the fourth driving transistor is switched from the OFF state to the ON state while maintaining the ON state of the third driving transistor; and

at least part of the first period and at least part of the second period are overlapped.

According to a eighth aspect of the present invention, there is provided a scanning device for scanning a plurality of scanning wirings, comprising:

the scanning circuit according to any one of the first aspect to the seventh aspect of the invention;

a control circuit for providing a first control signal for defining start and end of the first period and a second control signal for defining start and end of the second period with respect to the scanning circuit;

a first transmission line for transmitting the first control signal from the control circuit to the scanning circuit; and

a second transmission line for transmitting the second control signal from the control circuit to the scanning circuit.

According to a ninth aspect of the present invention, one of the first control signal and the second control signal is also used as a clock signal for defining a timing for switching a scanning wiring to be selected in the eighth aspect of the invention.

According to a tenth aspect of the present invention, there is provided a scanning device for scanning a plurality of scanning wirings, comprising:

the scanning circuit according to any one of the first aspect to the seventh aspect of the invention;

a control circuit for providing a control signal for defining start and end of the first period and defining start and end of the second period with respect to the scanning circuit; and

a transmission line for transmitting the control signal from the control circuit to the scanning circuit.

According to a eleventh aspect of the present invention, the control signal is also used as a clock signal for defining a timing for switching a scanning wiring to be selected in the tenth aspect of the invention.

In each invention explained above, a configuration in which the output unit satisfying the above requirements is arranged in correspondence to all the scanning wirings is suitably adopted.

According to a twelfth aspect of the present invention, there is provided an image display apparatus comprising:

the scanning circuit according to any one of the eighth aspect to the eleventh aspect of the present invention;

a plurality of scanning wirings;

a plurality of modulation wirings provided with a modulation signal;

a plurality of display elements matrix connected by the plurality of scanning wirings and the plurality of modulation wirings; and

a modulation circuit for providing the modulation signal to the modulation wirings.

According to a thirteenth aspect of the present invention, there is provided a television apparatus comprising:

the image display apparatus according to the twelfth aspect of the invention; and

a tuner for selecting a television broadcast signal, wherein

an image display is performed based on a signal output from the tuner.

### DESCRIPTION OF THE DRAWINGS

FIG. 1 is a schematic view showing an image display apparatus according to a first embodiment of the present invention;

FIG. 2 is a circuit diagram showing a scanning drive unit according to the first embodiment of the present invention;

FIG. 3 is a view showing a driving waveform of the scanning drive unit according to the first embodiment of the present invention;

FIG. 4 is a view showing a driving waveform of the scanning drive unit using an output enable signal;

FIG. 5 is a view showing a driving waveform of the scanning drive unit of when the rise time and the decay time are not the same according to the first embodiment of the present invention;

FIG. 6 is a circuit diagram showing an output buffer circuit according to the first embodiment of the present invention;

FIG. 7 is a view showing a circuit for generating a signal for driving the output buffer;

FIG. 8 is a view showing a waveform of the signal for driving the output buffer;

FIG. 9 is a view showing a driving waveform of the scanning drive unit of when the rise time and the decay time are the same according to a second embodiment of the present invention;

FIG. 10 is a view showing a driving waveform according to a third embodiment; and

FIG. 11 is a block diagram showing a set top box and a television apparatus using a matrix driving device according to the embodiment of the present invention.

### DETAILED DESCRIPTION OF THE INVENTION

The embodiments of the present invention will now be described with reference to the drawings. The same reference numerals are denoted for the same or the corresponding components throughout the drawings of the embodiment.

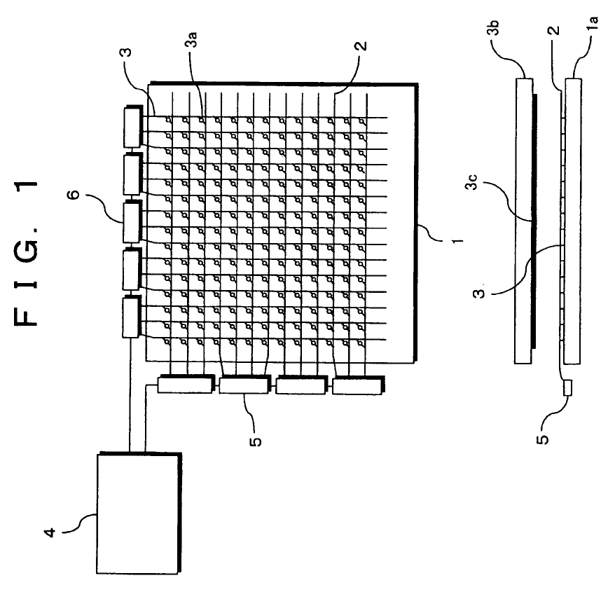

The image display apparatus according to the first embodiment of the present invention will first be explained. FIG. 1 shows an entire configuration of the image display apparatus using a surface conductive emission element according to the first embodiment.

As shown in FIG. 1, the image display apparatus according to the first embodiment is configured including a matrix panel 1, scanning wirings 2, modulation wirings 3, a control unit 4 serving as a control circuit, a scanning drive unit 5 serving as a scanning circuit including a scanning drive circuit such as a scanning drive IC, and a modulation drive unit 6 serving as a modulation circuit including a modulation drive circuit such as a modulation drive IC.

The matrix panel 1 is configured by having the surface conductive emission element 3a configuring a plurality of display elements connected into a matrix form with a plurality of scanning wirings 2 and a plurality of modulation wirings 3 on a rear panel 1a. A face plate 3b provided with the fluorescent material 3c is arranged facing the surface of the rear panel 1a provided with the wirings. A high voltage of, for example, about 10 kV is applied to the face plate 3b. The electrons emitted from the surface conductive emission element 3a are irradiated onto the fluorescent material 3c, thereby displaying pictures and images as the image display apparatus. In the first embodiment, a combination of the surface conductive emission element serving as an electron emitting element and a predetermined region of the fluorescent material where the emitted electrons are irradiated is used as the display element, but other various display elements such as EL element and the like may also be used.

The rear panel 1a is configured by arranging the surface conductive emission element 3a at the intersection of the scanning wiring 2 and the modulation wiring 3. In the matrix panel 1, the scanning drive unit 5 and the modulation drive unit 6 are controlled by means of the control unit 4, and electrons are emitted from the desired surface conductive emission element 3a when voltage of a dozens of volts etc. is applied between the scanning wiring 2 and the modulation wiring 3. The electrons emitted from the surface conductive emission element 3a reach the face plate 3b applied with an appropriate potential of between 1 kV to 30 kV and collide with the fluorescent material 3c, thereby emitting light. The brightness can be increased by increasing the amount of electrons that collide with the fluorescent material 3c during a predetermined period. Therefore, the brightness can be controlled by controlling either the current density or the current application period of the electrons, and gradation display becomes possible.

In the first embodiment, various pictures can be displayed by controlling the voltage to be applied to the scanning wiring 2 and the modulation wiring 3 with the control unit 4. Further, the brightness obtained by the light emission of the fluorescent material 3c increases with increase in time in which the electrons are collided, as described above. Therefore, it is essential to ensure the electron emitting period of the surface conductive emission element 3a, that is, the application time of the voltage on the surface conductive emission element 3a to increase brightness.

(Drive unit)

The scanning drive unit 5 is a drive circuit for applying the selected potential to one scanning wiring or to a plurality of specific scanning wirings 2 selected from a plurality of scanning wirings 2, and sequentially switching the selected scanning wiring 2. The scanning drive unit 5 is configured by an integrated circuit. When configured so that all the scanning wirings are each selectable in order by one integrated circuit, the path length from the integrated circuit to each scanning wiring greatly differs.

The scanning drive unit 5 is configured using four integrated circuits in the first embodiment to solve such problem. A predetermined voltage is applied to the scanning wiring 2 and an image is displayed on the matrix panel 1 by the scanning drive unit 5 configured in the above manner.

The modulation drive unit 6 is a drive circuit for controlling the output from a single or a plurality of constant voltage power supplies according to the input image signal, and applying the modulated modulation signal to each of a plurality of modulation wirings 3. The modulation drive unit 6 is configured by a plurality of integrated circuits (four integrated circuits in the embodiment). The control unit 4 is a control circuit for providing the image data to the scanning drive unit 5 and the modulation drive unit 6 to display the image on the matrix panel 1.

(Scanning drive unit)

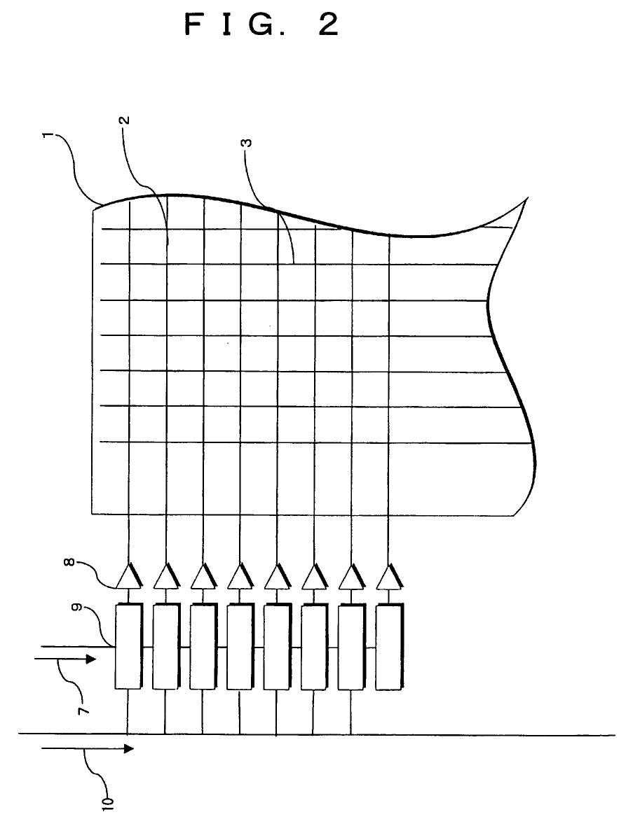

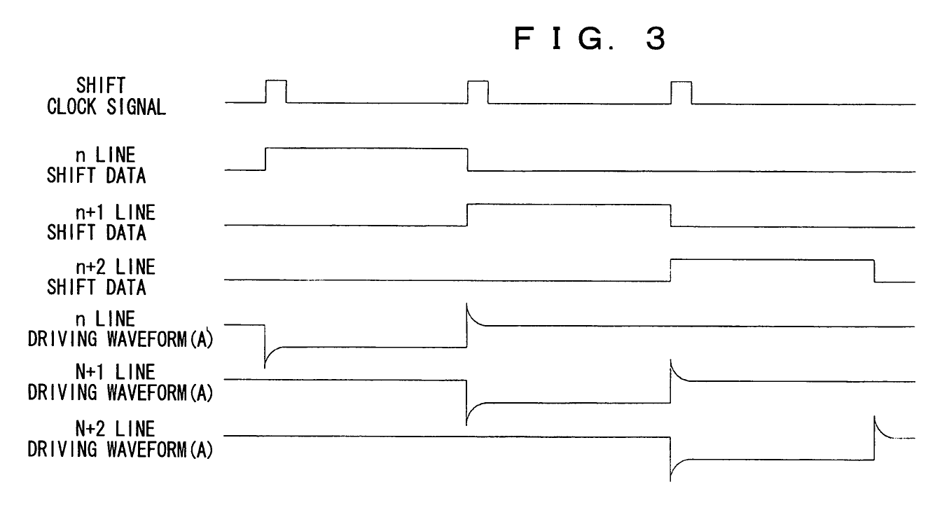

The basic driving operation of the scanning wiring by the scanning drive unit 5 will now be explained. FIG. 2 shows the section of the scanning drive unit 5 of the first embodiment, and FIG. 3 shows one example of the driving waveform of the scanning drive unit 5.

As shown in FIG. 2, the scanning drive unit 5 according to the first embodiment includes a shift register 9 that determines the driving line of the scanning wiring 2, and an output buffer 8 that converts the output of the shift register 9 to a voltage level necessary for driving the scanning wiring 2.

The shift clock signal 10 is provided in parallel through a first transmission line to each shift register 9. The shift data input from the shift data input 7 through a second transmission line is shifted in synchronization with the shift clock signal 10. The output buffers 8 are each connected to the scanning wiring 2.

When the shift data (n line shift data) is input to the output buffer 8 connected to the n^{th} scanning wiring from the top, the output buffer 8 outputs the selected signal to the connected scanning wiring 2. The waveform of the selected signal is the n line driving waveform (A) shown in FIG. 3. When the shift data (n+1 line shift data) is input to the output buffer 8 connected to the (n+1)^{th} scanning wiring, the relevant output buffer outputs the selected signal to the connected scanning wiring 2. The waveform of the selected signal in this case is the (n+1) line driving waveform (A) shown in FIG. 3. When the shift data (n+2 line shift data) is input to the output buffer 8 connected to the (n+2)^{th} scanning wiring, the relevant output buffer 8 outputs the selected signal to the connected scanning wiring 2. The waveform of the selected signal in this case is the (n+2) line driving waveform (A) shown in FIG. 3. Similar output is made for the subsequent shift registers 9, and the scanning wirings 2 are sequentially driven.

When the above described drive is performed, the driving waveform has undershoot and overshoot since the scanning wiring contains inductance component. Each driving waveform is connected to the scanning wirings 2 adjacent to each other. Thus, a phenomenon occurs in which the adjacent scanning wirings 2 influence each other due to the mutual induction and the electrostatic capacity in between.

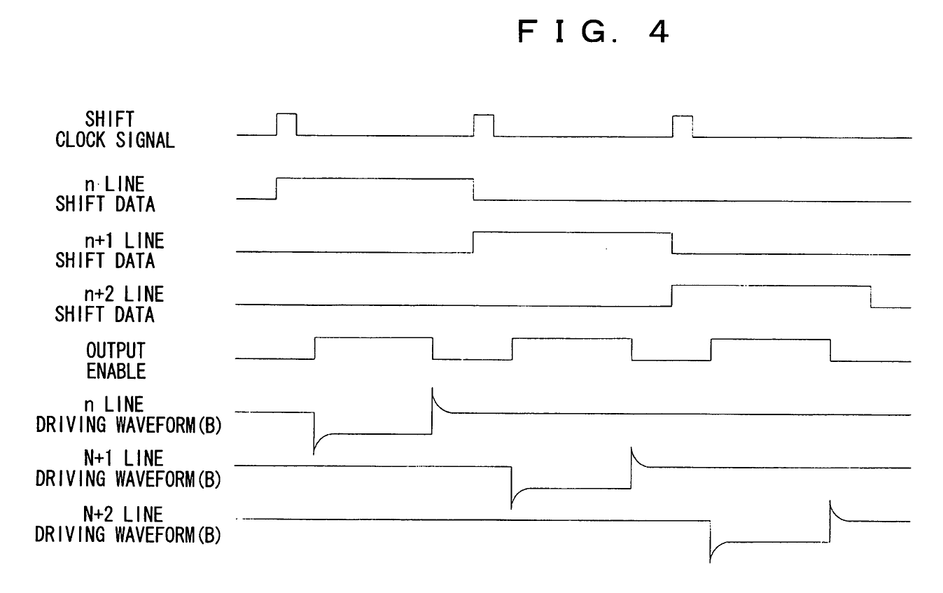

One aspect for countering such situation is to input an output enable 7 to the scanning drive unit 5, as shown in FIG. 4. A logical multiplication (AND control) between the shift data and the output enable is performed, and only the period in which the output enable is Hi is selected. Thus, a driving method in which overshoot and undershoot are not brought close can be adopted. However, the brightness reduces since the selected period of each scanning wiring 2 reduces in such driving method.

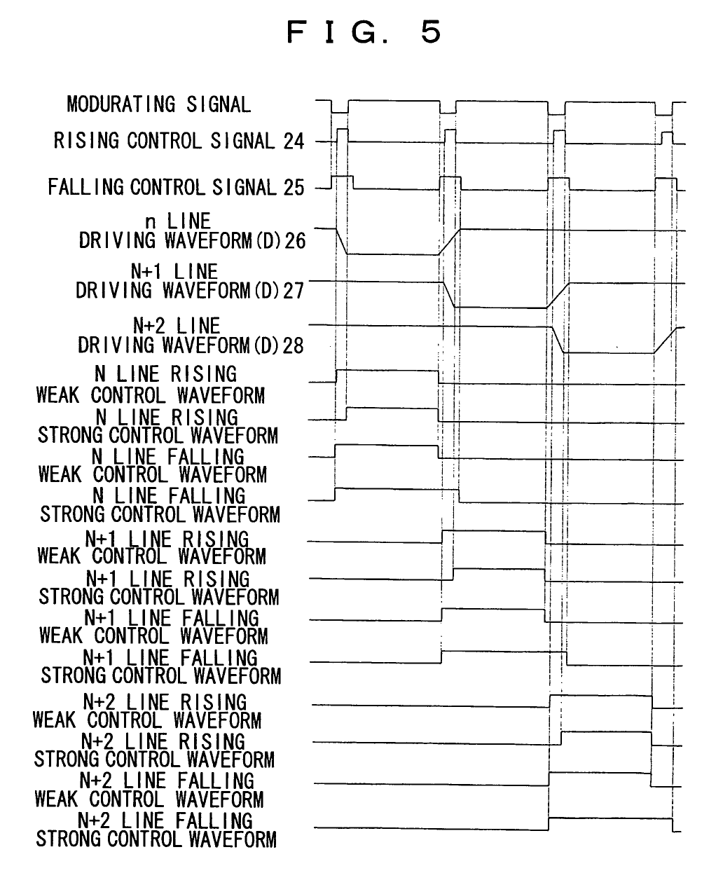

The following configuration is adopted to solve the problem in the first embodiment. Specifically, the overshoot and undershoot of the driving waveform are suppressed by controlling the slew rate of the driving waveform. Especially, it is suitable to spend 100 nsec or more for transition (transition from ON potential to OFF potential, or from OFF potential to ON potential) of potential. This transition period can be set as a desired value with timing signal mentioned after. When the slew rate of the driving wave form is controlled, the time required for transition increases. In this embodiment, the transition from the selected to the non-selected in the n line driving waveform D(26) and the transition from the non-selected to the selected in the (n+1) line driving waveform D(27) are overlapped as shown in FIG. 5. It is possible to control earned hours (time which can be used for applying modulating signal). Especially, The composition in which the transition to unselected state from selected state and the transition to selected state from unselected state are completely overlapped in the same timing is suitable. In addition, in order to control shortening of earned hours, it is suitable that each of the first period and second period does not exceed 2 microseconds. [0037]

A stability waiting time of the waveform such as in FIG. 4 is required when overshoot and undershoot are present. However, the stability waiting time of the waveform is unnecessary in the first embodiment since the slew rate of the driving waveform can be controlled.

Further, the transition from the selected to the non-selected in the n line driving waveform (D) and the transition from the non-selected to the selected in the (n+1) line driving waveform (D) are overlapped. The shortening of the selected period is thereby suppressed. Although it is hereinafter described in detail, the signal output from the control unit 4 to control the driving waveform includes a rise control signal 24 and a decay control signal 25 as shown in FIG. 5. In order to reduce the number of control signals of the driving waveform, the shift clock signal shown in FIG. 5 may also used as the rise control signal 24.

In the first embodiment, the shift clock signal 10 is transmitted through the first transmission line, and the decay control signal 25 is transmitted through the second transmission line. The reduction in the selected period of the scanning wiring 2 is suppressed, and the reduction of brightness is suppressed by using the first transmission line and the second transmission line. This will be specifically explained below.

(Modulation Signal)

The modulation signal will now be explained. Normally, the integrated value of luminance becomes larger as the pulse width in the pulse width modulation (PWM) becomes wider in the image display apparatus employing the surface conductive emission element 3a. Therefore, the displayed brightness becomes brighter as the pulse width in the pulse width modulation (PWM) becomes wider. In the driving method shown in FIG. 4, in order to avoid the adverse affect of the signal diving to the adjacent scanning wiring 2 by the influence of undershoot in time of decay and of overshoot in time of rise and the like, the next drive is performed after a certain time is waited until the undershoot or overshoot settles (flattening waiting time), so that the occurrence of undershoot or overshoot etc., a so-called linking is settled. Thus, the maximum pulse width of PWM by the driving method of FIG. 4 becomes,
maximum pulse width of PWM=one scanning time−(decay time+decay undershoot flattening waiting time+rise time+rise overshoot flattening waiting time)

In the first embodiment, the rise and decay of the drive signal are overlapped using two control signals when performing a slew rate control. Thus, maximum pulse width of PWM becomes,
maximum pulse width of PWM=one scanning time−(decay time or rise time). That is,
the maximum pulse width of PWM can be widened by (decay undershoot flattening waiting time+rise time (or decay time)+rise overshoot flattening waiting time).

The modulation signal thus becomes a PWM signal having a period from the timing at which the decay transition period at each line ends to the timing at which the rise transition period of each line starts as the maximum PWM pulse width.

(Rise Control and Decay Control)

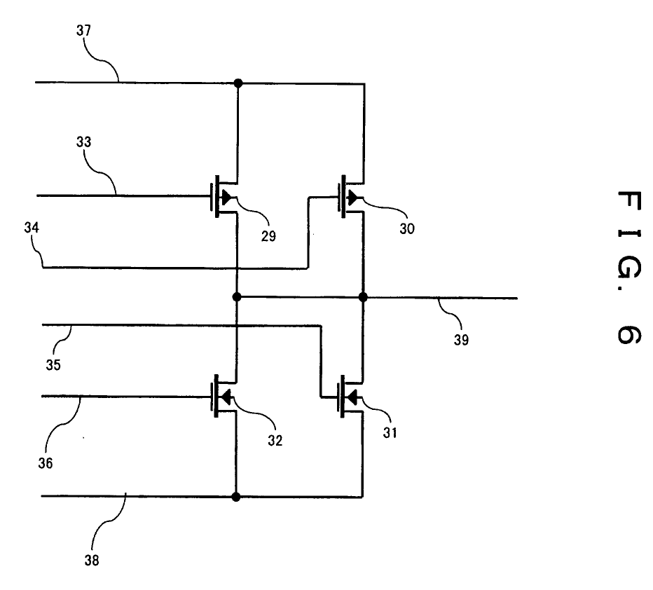

The rise control and the decay control according to the first embodiment will now be explained. FIG. 5 shows a timing chart of the rise control and the decay control, and FIG. 6 shows a circuit diagram of the output buffer 8 according to the first embodiment.

As shown in FIG. 6, the output buffer 8 according to the first embodiment is configured by a decay WEAK driving (drive at weak current) MOS transistor 29 and a decay STRONG driving (drive at strong current) MOS transistor 30 configured by a p-channel MOS transistor; and a rise STRONG driving MOS transistor 31 and a rise WEAK driving MOS transistor 32 configured by an n-channel MOS transistor.

The circuit operation of the output buffer 8 will now be specifically explained. In the first embodiment, since the potential of the scanning wiring is in the selected state at low level, the potential is lowered at the rise of the selected signal and the potential is risen at the decay of the selected signal.

In FIG. 6, the selected potential is the potential supplied to the power supply line 38, whereas the non-selected potential is the potential supplied to the power supply line 37. Actually, due to the on-resistance of the driving transistor and the resistance in the electrically conductive path, the potential (equivalent to “ON potential” of the present invention) supplied to the scanning wiring maintained at the selected state differs from the potential supplied to the power supply line 38.

The potential (equivalent to “OFF potential” of the present invention) supplied to the scanning wiring maintained at the non-selected sate differs from the potential supplied to the power supply line 37. In the following embodiment, the “selected potential 38” is treated as the potential to be supplied to the power supply line 38 and the “non-selected potential 37” is treated as the potential to be supplied to the power supply line 37 in order to avoid redundant explanation.

First, the drive signal 36 of the rise WEAK driving MOS transistor 32 becomes Hi at the rise of the rise control signal 24 of FIG. 5, and the rise WEAK driving MOS transistor 32 is turned ON. The rise WEAK driving MOS transistor 32 has a large on-resistance of, for example, about 1 kΩ. At this rise WEAK driving MOS transistor 32, the current is slowly supplied from the scanning output 39 and the potential of the scanning output 39 is lowered to the selected potential 38. The scanning wiring connected with the output buffer shown in FIG. 6 is thereby in the selected state.

When the rise control signal 24 serving as the first control signal shown in FIG. 5 is in the decay state at a timing the potential of the scanning output 39 becomes the selected potential 38, the drive signal 35 of the rise STRONG driving MOS transistor for driving the rise STRONG driving MOS transistor 31 becomes Hi, and the rise STRONG driving MOS transistor 31 is turned ON. The rise STRONG driving MOS transistor 31 has a greater driving ability than the rise WEAK driving MOS transistor 32 since it is set to the on-resistance of a few Ω. That is, the on-resistance is smaller than with the rise WEAK driving MOS transistor 32, and a greater current can be flowed. The scanning output 39 is already converging to the potential of the selected potential 38 at this point. Thus, the occurrence of undershoot is prevented in the scanning output 39.

The period from the front end to the last end of one pulse of the rise control signal corresponds to a first period. Thereafter, at decay of waveform, in the first embodiment, until the rise of the potential from the selected potential starts, a state in which the scanning wiring is driven with the two transistors connected in parallel, both the rise WEAK driving MOS transistor 32 and the rise STRONG driving MOS transistor 31, that is, a state in which the selected potential is provided by both transistors is obtained. That is, the driving ability is made different between the rise start time of the selected signal and the ON state maintaining time of the selected signal. Specifically, the driving ability is made to be greater for when maintaining the ON state than at the start of rise.

In the first embodiment, a suitable slew rate is achieved with a configuration satisfying the two conditions of,

(1) The number of transistors to be turned ON in maintaining the ON state is greater than the number of transistors to be turned ON at the start of rise; and

(2) The driving ability of the transistor that is not turned ON at the start of rise and that is only turned ON in maintaining the ON state is greater compared to the driving ability of the transistor to be turned ON at the start of rise.

The conditions are not limited thereto in the first embodiment and the slew rate can be appropriately set by satisfying only one of the two conditions. For example, a configuration of using the two transistors of the same driving ability, and turning ON only one transistor at the start of rise of the selected signal, and turning ON two transistors after the selected signal has risen to a predetermined state, thereby maintaining the ON state of the selected signal is adopted. In relation thereto, this is the same for when decaying the selected signal, that is, when raising the potential of the selected signal to the non-selected state in the first embodiment.

The decay timing (timing at which the rise STRONG driving MOS transistor is turned ON) of the rise control signal 24 is set to be the same as the timing (lowers to the selected potential) at which the potential of the scanning output rises to the selected potential, but is not limited to thereto. If the timing at which the rise STRONG driving MOS transistor is turned ON is faster than the timing at which the potential of the scanning output rises to the selected potential (lowers to the selected potential), the drive at a large driving ability starts in the middle of the transition period from the non-selected potential to the selected potential, and rapidly reaches the selected potential thereafter.

As described above, one pulse of the rise control signal 24 is used in defining the two timings. Specifically, the timing to start the rise of the selected signal (start of rise transition period) is defined by the front end of one pulse, and the timing to start the selected drive at the driving ability greater than at the start of rise is defined by the last end of the one pulse.

At the rise of the decay control signal 25 shown in FIG. 5, the drive signal 33 of the decay WEAK driving MOS transistor 29 becomes Lo, and the decay WEAK driving MOS transistor 29 is turned ON. Since the decay WEAK driving MOS transistor 29 has a large on-resistance of, for example, about 1 kΩ, the current is slowly supplied to the scanning output 39 and the scanning output 39 rises to the non-selected potential 37.

When the decay control signal 25 is decayed at a timing the scanning output 39 becomes the potential of the non-selected potential 37, the drive signal 34 of the decay STRONG driving MOS transistor 30 becomes Lo, and the decay STRONG driving MOS transistor 30 is turned ON.

Since the decay STRONG driving MOS transistor 30 is set to the on-resistance of a few Ω, it can be driven even at a large current. That is, the decay STRONG driving MOS transistor 30 has a driving ability (small on-resistance) greater than the decay WEAK driving MOS transistor 29. The scanning output 39 is already at the non-selected potential 37 and balanced at this point. Thus, the occurrence of overshoot is prevented in the scanning output 39.

A period from the front end to the last end of one pulse of the decay control signal 25 serving as the second control signal corresponds to a second period. The decay timing (timing at which the decay STRONG driving MOS transistor 30 is turned ON) of the decay control signal 25 in the first embodiment is set to be the same as the timing at which the potential of the scanning output decays to the non-selected potential (rise to the non-selected potential), but is not limited thereto. If the timing at which the decay STRONG driving MOS transistor 30 is turned ON is faster than the timing at which the potential of the scanning output decays to the non-selected potential (rise to the non-selected potential), the drive by the large driving ability starts in the middle of the transition period from the selected potential to the non-selected potential, and rapidly reaches the non-selected potential thereafter.

As described above, one pulse of the decay control signal 25 is used in defining the two timings. Specifically, the timing to start the decay of the selected signal (start of decay transition period) is defined by the front end of the one pulse, and the timing to start the non-selected drive at the driving ability greater than at the start of decay is defined by the last end of the one pulse.

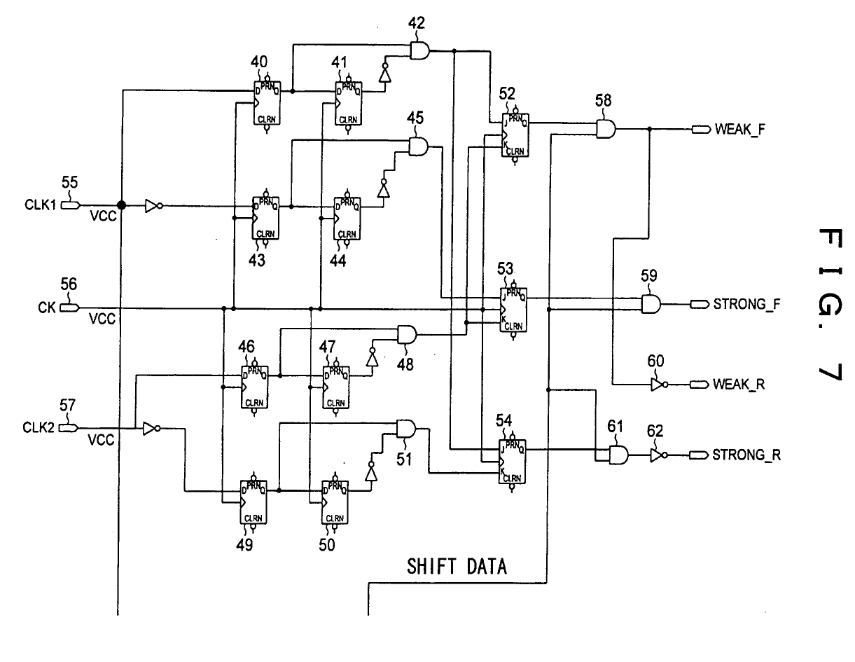

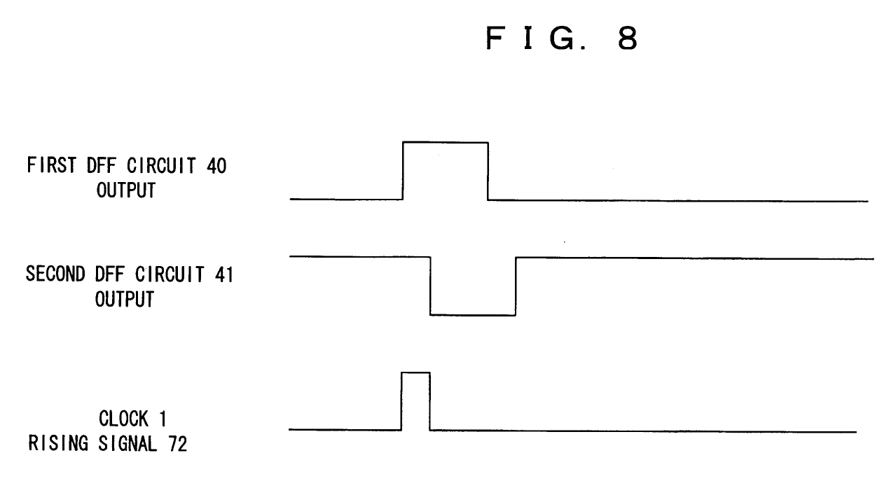

A circuit for generating the signals 33, 34, 35, 36 for driving the output buffer of FIG. 6 from the rise control signal 24 and the decay control signal 25 will now be specifically explained with reference to FIG. 7 and FIG. 8.

That is, the rise control signal 24 is input to the input 55 as clock 1. The decay control signal 25 is input to the input 57 as clock 2. The reference clock is input to the input 56. Continuous clock signals of, for example, about 1 MHz are used as the reference clock.

In FIG. 7, the detection of the rise of the rise control signal is performed by a first DFF circuit 40, a second DFF circuit 41, and a first AND circuit 42.

That is, as shown in FIG. 8, the logical multiplication of the output of the first DFF circuit 40 and the output of the second DFF circuit 41 shown in FIG. 7 is obtained, and the rise signal 72 indicating the rise timing of the clock 1, which is the rise control signal 24, is obtained.

Similarly, although the illustration of the waveform is omitted, the decay of the rise control signal is detected by a third DFF circuit 43, a fourth DFF circuit 44, and a second AND circuit 45, and a signal indicating the decay timing of the rise control signal 24 is obtained. With regards to the clock 2 signal, which is the decay control signal 25, the detection of rise is performed by a fifth DFF circuit 46, a sixth DFF circuit 47, and a third AND circuit 48, and a signal indicating the rise of the decay control signal 25 is obtained.

The detection of decay is performed with a seventh DFF circuit 49, an eighth DFF circuit 50, and a fourth AND circuit 51, and a signal indicating the decay of the decay control signal is obtained. Four signals each indicating the rise and decay of clock 1 and clock 2 are thereby obtained.

The n line rise WEAK drive signal 36 of FIG. 5 is obtained by deriving the logical multiplication of the output of a first JKFF circuit 52 using the output of the first AND circuit 42 and the output of the third AND circuit 48 and the n line shift data from these signals, and the n line decay WEAK control signal 33 can be obtained by inverting such signal.

Similarly, the n line rise STRONG drive signal 35 of FIG. 5 is obtained by deriving the logical multiplication of the output of a second JKFF circuit 53 using the output of the second AND circuit 45 and the output of the third AND circuit 48, and the n line shift data, and the n line decay STRONG drive signal 34 is obtained using the inverted signal of the logical multiplication of the output of a third JKFF circuit 54 using the output of the first AND circuit 42 and the output of the fourth AND circuit 51, and the n line shift data.

Similarly, the respective control signal is obtained with regards to n+1 line, n+2 line by using the n+1 line shift data and the n+2 line shift data in place of the n line shift data.

A waveform generation method by detecting the rise and decay using the reference clock has been explained in the first embodiment described above, but is not necessarily limited thereto, and similar effects are obtained using a method of detecting rise and decay using a differentiation circuit and the like.

As described above, the dive of noise caused by mutual induction and electrostatic capacity between the scanning wirings is suppressed by controlling the slew rate of the waveform of the transition period. Thus, the transition period of rise of the n line driving waveform (C) and the transition period of the decay of the n+1 line driving waveform (C) can be overlapped. Therefore, reduction of brightness is suppressed.

Since the surface conductive emission element 3a has the impedance changed by the application potential and has the required driving ability with respect to sink and source of the scanning drive unit 5 differ with respect to each other, the impedances of the sink and the source differ. Therefore, the most suitable transition period is not necessarily the same time for the rise and the decay.

In such case, four timings are defined using the front end and the last end of the pulse of the control signal of the two control signals, and the front end and the last end of the pulse of the other control signal by transmitting the two control signals using two transmission lines.

Specifically, the waveform of the transition period is smoothly transitioned, and the simultaneous process of the rise waveform and the decay waveform can be executed by controlling the pulse width of the decay control signal and the rise control signal or the positional relationship between the decay control signal and the rise control signal as shown in FIG. 5. In the first embodiment, a configuration of sequentially selecting the scanning wiring one at a time has been explained, but may be a configuration of simultaneously selecting a plurality of scanning wirings, as in the configuration of simultaneously selecting two scanning wirings and sequentially selecting two at a time. Further, a configuration of sequentially selecting the scanning wiring (line) one at a time is preferable in terms of fine display.

### Second Embodiment

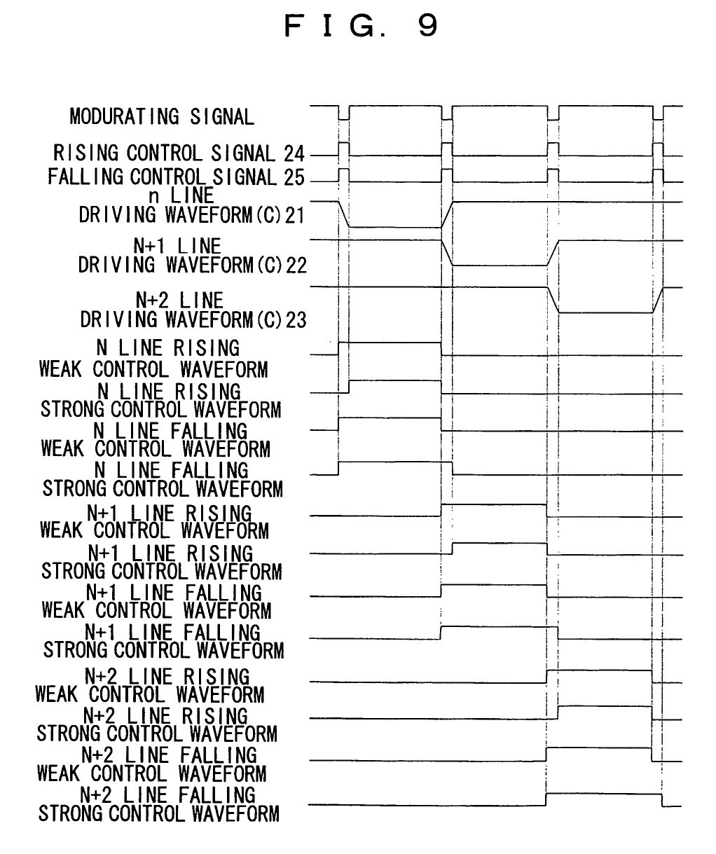

A matrix driving device according to a second embodiment of the present invention will now be explained. FIG. 9 shows a control timing chart of the scanning drive unit 5 of the matrix driving device according to the second embodiment.

That is, when the transition time of most suitable rise and the transition time of most suitable decay are the same due to the property of panel load, or when the transition time of most suitable rise and the transition time of most suitable decay are different but is negligibly small, from the start to the end of rise control (“end of rise control” specifically means the start of drive at a driving ability greater than at the start of rise) and the start to the end of decay control (“end of decay control” specifically means the start of drive at a driving ability greater than at the start of decay) can be completely overlapped. Here, “completely overlap” means that the decay control period of a predetermined line and the rise transition period of the next line start simultaneously and end simultaneously.

As shown in FIG. 9, the pulse width of the decay control signal 25 and the pulse width of the rise control signal 24 are made to have the same pulse width and the control timings are coincided in the second embodiment. Other configurations and operations are the same as in the first embodiment, and thus the explanation of the same components is omitted.

First, when the decay control signal and the rise control signal are at the same timing and have the same pulse width, the transition from selected to non-selected of the n line driving waveform and the transition from non-selected to the selected of the n+1 line are simultaneously performed, as shown in FIG. 9.

In this case, the decay control signal and the rise control signal are coincided to be formed by a single signal. In this case, the control signal for performing the slew rate control only needs to be either the rise control signal 24 or the decay control signal 25.

Further, the rise control signal may also be used as the shift clock signal, as explained in the first embodiment. Specifically, the shift clock signal may be used as the control signal and the two timings may be defined by the front end and the last end of one pulse of the shift clock.

The start of decay of the selected signal, that is, the start of transition to the non-selected potential of the n line, and the start of rise of the selected signal, that is, the start of transition to the selected potential of the n+1 line are performed in accordance with one of the two timings; and the end of the decay transition period of the selected signal of the n line or the start of the non-selected drive at the driving ability greater than at the start of decay of the selected signal of the n line, and the end of the rise transition period of the selected signal of the (n+1) line or the start of the selected drive at the driving ability greater than at the time of start of rise of the selected signal of the (n+1) line are performed in accordance with the other timing.

Alternatively, a configuration for providing a control signal, aside from the shift clock, also used as the rise control signal 24 and the decay control signal 25 from the control unit 4 may be adopted.

### Third Embodiment

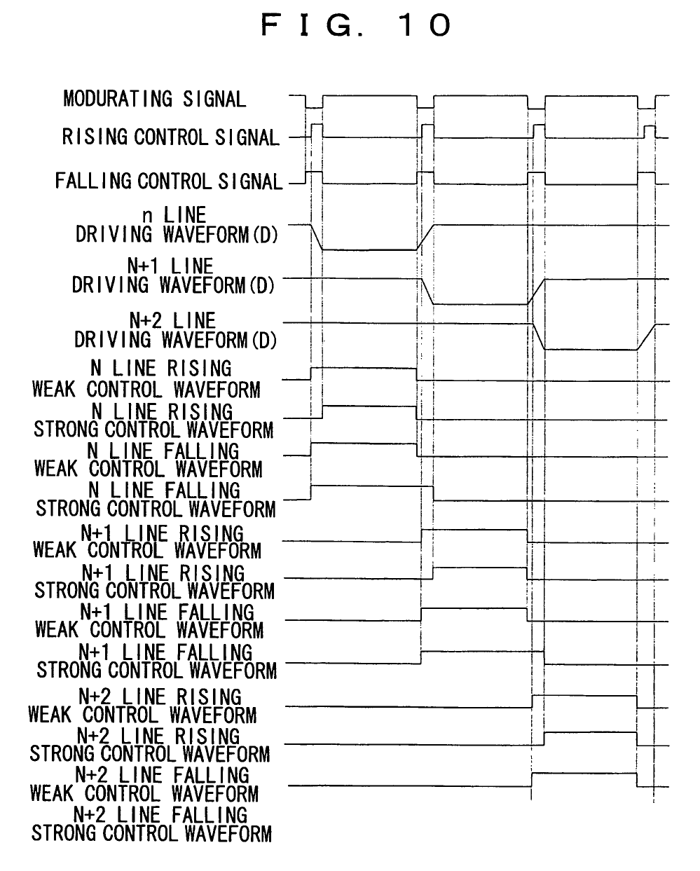

A third embodiment of the present invention will now be described. FIG. 10 shows a control timing chart of the scanning drive unit 5 of a matrix driving device according to the third embodiment. In the third embodiment, when the most suitable rise transition period and the most suitable decay transition period of the driving waveform differ, the timing at which the transition from the selected to the non-selected of the n line driving waveform ends and the timing at which the transition from the non-selected to the selected of the (n+1) line ends are made to be the same timing.

As shown in FIG. 10, the timing of decay of the decay control signal and the timing of decay of the rise control signal are the same in the third embodiment. Therefore, the transition from the selected to the non-selected of a long time has the starting time of transition set earlier by widening the pulse width of the decay control signal. Thus, the timings at which the transitions end become the same and the drive of the modulation wiring becomes possible immediately after transition is ended. As a result, the selected period of the scanning wiring 2 can be increased, and the lowering of display luminance can be suppressed.

As explained above, a case of when the timing of decay of the decay control signal and the timing of decay of the rise control signal are the same is explained in the third embodiment, but the timing of rise of the decay control signal and the timing of rise of the rise control signal may be the same. In this case, the starting time of the transition from the selected to the non-selected of the n line and the starting time of the transition from the non-selected to the selected of the (n+1) line are made the same, so that the drive of the modulation wiring becomes possible until just before, similar to the third embodiment. As a result, the selected period of the scanning wiring 2 can be increased, and lowering of display luminance can be suppressed.

(Television Apparatus)

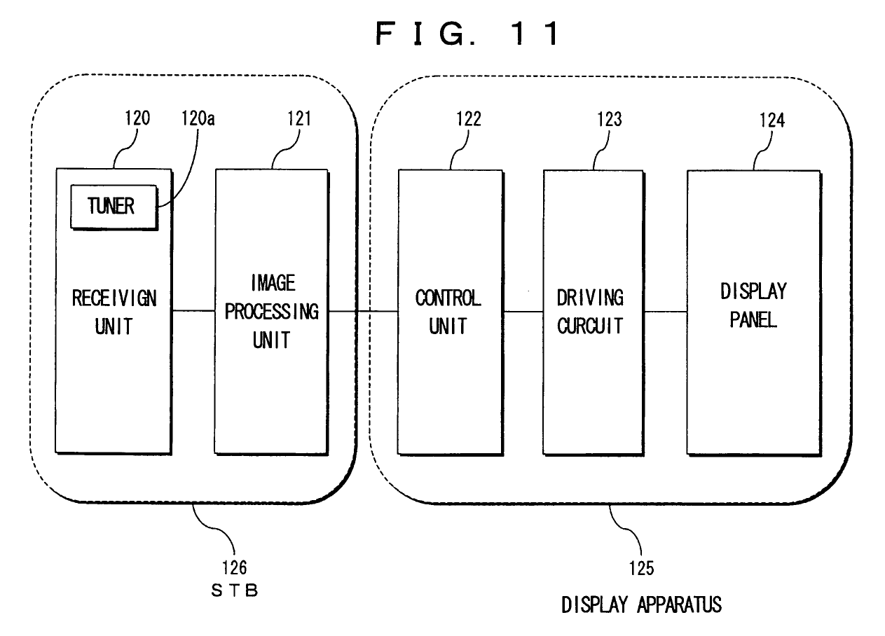

A television apparatus using the matrix driving device according to the above described first to the third embodiments will now be explained. FIG. 11 shows a television apparatus using the matrix driving device of the first to the third embodiments descried above.

As shown in FIG. 11, the television apparatus is configured including a receiving circuit 120 arranged with a broadcast signal tuner 120a, an image processing unit 121, and a display device 125 including a control unit 122, a driving circuit 123 including the above described matrix driving device, and a display panel 124.

The receiving circuit 120 is configured including the broadcast signal tuner 120, a decoder and the like. The receiving circuit 120 receives a television signal such as satellite broadcast or ground wave, data broadcast via the network and the like and outputs the decoded picture data to the image processing unit 121.

The image processing unit 121 is configured including a γ correction circuit or a resolution conversion circuit, an interface (I/F) circuit and the like. The image processing unit 121 converts the image processed picture data to the display format of the display device and outputs the image data to the display device 125.

The display device 125 is configured including the display panel 124, the driving circuit according to the above described first to the third embodiments including the scanning drive unit 5 and the modulation drive unit 6, and the control unit 122. The control unit 122 performs signal processing such as correction process suited to the display panel on the input picture image, and outputs the image data and various control signals to the driving circuit 123. The driving circuit 123 is configured so as to provide the drive signal to the display panel 124 based on the input image data. The television pictures are then displayed on the display panel 124.

The receiving circuit 120 and the image processing unit 121 may be accommodated in a housing separate from the display device 125 as a set top box (STB) 126, or may be accommodated in the housing integrated with the display device 125, or various forms of combinations may be adopted other than the above.

The embodiments of the present invention have been specifically explained, but the present invention is not limited thereto, and various modifications are possible based on the technical concept of the present invention.

The matrix driving device and the driving method thereof of the present invention encompasses a liquid crystal display device, a plasma display device, an electron beam display device and the like. The application of the present invention is preferable on the plasma display device or the electron beam display device, in particular, due to the property in which the output luminance increases proportional to the voltage application time.

According to the present invention, the decrease in the display period due to the presence of the transition period can be suppressed.

This application claims priority from Japanese Patent Application No. 2005-128077 filed Apr. 26, 2005, and Japanese Patent Application No. 2006-112036 filed Apr. 14, 2006, which are hereby incorporated by reference herein.

What is claimed is:

1. A scanning circuit having a plurality of output units each outputs an ON potential sequentially, comprising:
a first output unit that changes an ON potential to an OFF potential taking a first period; and
a second output unit that changes an OFF potential to an ON potential taking a second period, wherein
at least part of the first period and at least part of the second period overlap.

2. A scanning circuit for scanning a plurality of scanning wirings, comprising:
a first output unit connected to a first scanning wiring; and
a second output unit connected to a scanning wiring different from the first scanning wiring, wherein
said first output unit starts an output with a first driving ability to start a change for approaching a signal level to be output to a signal level of a non-selected state, when said first output unit is in a state performing an output of a signal level for having the first scanning wiring to a selected state, and starts an output with a second driving ability greater than the first driving ability after a first period;
said second output unit starts an output with a third driving ability to start a change for approaching a signal level to be output to a signal level of a selected state, when said second output unit is in a state performing an output of a signal level for having the scanning wiring to be selected after the first scanning wiring is selected to a non-selected state, and starts an output with a fourth driving ability greater than the third driving ability after a second period; and
at least part of the first period and at least part of the second period are overlapped.

3. A scanning circuit according to claim 2, wherein the first scanning wiring is maintained at the signal level of a non-selected state by the second driving ability, and the scanning wiring to be selected after the first wiring is maintained at the signal level of the selected state by the fourth driving ability.

4. A scanning circuit for scanning a plurality of scanning wirings, comprising:
a first output unit connected to a first scanning wiring; and
a second output unit connected to a scanning wiring different from the first scanning wiring, wherein
said first output unit includes:
a first driving transistor for switching from an OFF state to an ON state to start a change of approaching a signal level to be output to a signal level of a non-selected state when said first output unit is in a state performing an output of a signal level for having the first scanning wiring to a selected state; and
a second driving transistor, maintained at an OFF state when said first driving transistor is switched from the OFF state to the ON state, for switching from an OFF state to an ON state after a first period from when said first driving transistor is switched from the OFF state to the ON state;
said second output unit includes:
a third driving transistor for switching from an OFF state to an ON state to start a change of approaching a signal level to be output to a signal level of a selected state when said second output unit is in a state performing an output of a signal level for having a scanning wiring to be selected after the first scanning wiring is selected to a non-selected state; and
a fourth driving transistor, maintained at an OFF state when said third driving transistor is switched from the OFF state to the ON state, for switching from an OFF state to an ON state after a second period from when said third driving transistor is switched from the OFF state to the ON state, wherein
said second driving transistor has a driving ability greater than said first driving transistor; and
at least part of the first period and at least part of the second period are overlapped.

5. A scanning circuit for scanning a plurality of scanning wirings, comprising:
a first output unit connected to a first scanning wiring; and
a second output unit connected to a scanning wiring different from the first scanning wiring, wherein
said first output unit includes:
a first driving transistor for switching from an OFF state to an ON state to start a change of approaching a signal level to be output to a signal level of a non-selected state when said first output unit is in a state performing an output of a signal level for having the first scanning wiring to a selected state; and
a second driving transistor, maintained at an OFF state when said first driving transistor is switched from the OFF state to the ON state, for switching from an OFF state to an ON state after a first period from when said first driving transistor is switched from the OFF state to the ON state;
said second output unit includes:
a third driving transistor for switching from an OFF state to an ON state to start a change of approaching a signal level to be output to a signal level of a selected state when said second output unit is in a state performing an output of a signal level for having a scanning wiring to be selected after the first scanning wiring is selected to a non-selected state; and
a fourth driving transistor, maintained at an OFF state when said third driving transistor is switched from the OFF state to the ON state, for switching from an OFF state to an ON state after a second period from when said third driving transistor is switched from the OFF state to the ON state, wherein
said fourth driving transistor has a driving ability greater than said third driving transistor; and
at least part of the first period and at least part of the second period are overlapped.

6. A scanning circuit for scanning a plurality of scanning wirings, comprising:
a first output unit connected to a first scanning wiring; and
a second output unit connected to a scanning wiring different from the first scanning wiring, wherein
said first output unit includes:
a first driving transistor for switching from an OFF state to an ON state to start a change of approaching a signal level to be output to a signal level of a non-selected state when said first output unit is in a state performing an output of a signal level for having the first scanning wiring to a selected state; and
a second driving transistor, maintained at an OFF state when said first driving transistor is switched from the OFF state to the ON state, for switching from an OFF state to an ON state after a first period from when said first driving transistor is switched from the OFF state to the ON state;
said second output unit includes:
a third driving transistor for switching from an OFF state to an ON state to start a change of approaching a signal level to be output to a signal level of a selected state when said second output unit is in a state performing an output of a signal level for having a scanning wiring to be selected after the first scanning wiring is selected to a non-selected state; and
a fourth driving transistor, maintained at an OFF state when said third driving transistor is switched from the OFF state to the ON state, for switching from an OFF state to an ON state after a second period from when said third driving transistor is switched from the OFF state to the ON state, wherein
said second driving transistor is switched from the OFF state to the ON state while maintaining the ON state of said first driving transistor; and
at least part of the first period and at least part of the second period are overlapped.

7. A scanning circuit for scanning a plurality of scanning wirings, comprising:
a first output unit connected to a first scanning wiring; and
a second output unit connected to a scanning wiring different from the first scanning wiring, wherein
said first output unit includes:
a first driving transistor for switching from an OFF state to an ON state to start a change of approaching a signal level to be output to a signal level of a non-selected state when said first output unit is in a state performing an output of a signal level for having the first scanning wiring to a selected state; and
a second driving transistor, maintained at an OFF state when said first driving transistor is switched from the OFF state to the ON state, for switching from an OFF state to an ON state after a first period from when said first driving transistor is switched from the OFF state to the ON state;
said second output unit includes:
a third driving transistor for switching from an OFF state to an ON state to start a change of approaching a signal level to be output to a signal level of a selected state when said second output unit is in a state performing an output of a signal level for having a scanning wiring to be selected after the first scanning wiring is selected to a non-selected state; and
a fourth driving transistor, maintained at an OFF state when said third driving transistor is switched from the OFF state to the ON state, for switching from an OFF state to an ON state after a second period from when said third driving transistor is switched from the OFF state to the ON state, wherein
said fourth driving transistor is switched from the OFF state to the ON state while maintaining the ON state of said third driving transistor; and
at least part of the first period and at least part of the second period are overlapped.

8. A scanning device for scanning a plurality of scanning wirings, comprising:
said scanning circuit according to claim 1;
a control circuit for providing a first control signal for defining start and end of the first period and a second control signal for defining start and end of the second period with respect to said scanning circuit;
a first transmission line for transmitting the first control signal from said control circuit to said scanning circuit; and
a second transmission line for transmitting the second control signal from said control circuit to said scanning circuit.

9. A scanning device according to claim 8, wherein one of the first control signal and the second control signal is also used as a clock signal for defining a timing for switching a scanning wiring to be selected.

10. A scanning device for scanning a plurality of scanning wirings, comprising:
said scanning circuit according to claim 1;
a control circuit for providing a control signal for defining start and end of the first period and defining start and end of the second period with respect to said scanning circuit; and
a transmission line for transmitting the control signal from said control circuit to said scanning circuit.

11. A scanning device according to claim 10, wherein the control signal is also used as a clock signal for defining a timing for switching a scanning wiring to be selected.

12. An image display apparatus comprising:
said scanning circuit according to claim 1;
a plurality of scanning wirings;
a plurality of modulation wirings provided with a modulation signal;
a plurality of display elements matrix connected by the plurality of scanning wirings and the plurality of modulation wirings; and
a modulation circuit for providing the modulation signal to the modulation wirings.

13. A television apparatus comprising:
the image display apparatus according to claim 12; and
a tuner for selecting a television broadcast signal, wherein
an image display is performed based on a signal output from the tuner.

14. A scanning device for scanning a plurality of scanning wirings, comprising:
said scanning circuit according to claim 2;
a control circuit for providing a control signal for defining start and end of the first period and defining start and end of the second period with respect to said scanning circuit; and
a transmission line for transmitting the control signal from said control circuit to said scanning circuit.

15. A scanning device for scanning a plurality of scanning wirings, comprising:
said scanning circuit according to claim 4;
a control circuit for providing a control signal for defining start and end of the first period and defining start and end of the second period with respect to said scanning circuit; and
a transmission line for transmitting the control signal from said control circuit to said scanning circuit.

16. A scanning device for scanning a plurality of scanning wirings, comprising:
said scanning circuit according to claim 5;
a control circuit for providing a control signal for defining start and end of the first period and defining start and end of the second period with respect to said scanning circuit; and
a transmission line for transmitting the control signal from said control circuit to said scanning circuit.

17. A scanning device for scanning a plurality of scanning wirings, comprising:
said scanning circuit according to claim 6;
a control circuit for providing a control signal for defining start and end of the first period and defining start and end of the second period with respect to said scanning circuit; and
a transmission line for transmitting the control signal from said control circuit to said scanning circuit.

18. A scanning device for scanning a plurality of scanning wirings, comprising:
said scanning circuit according to claim 7;
a control circuit for providing a control signal for defining start and end of the first period and defining start and end of the second period with respect to said scanning circuit; and
a transmission line for transmitting the control signal from said control circuit to said scanning circuit.
